(19) United States
(12) Patent Application Publication
(10) Pub. No.: US 2013/0091146 A1
(43) Pub. Date: Apr. 11, 2013

(54) DETERMINATION OF MOBILE USER PROFILE AND PREFERENCES FROM MOVEMENT PATTERNS

(71) Applicant: WiFarer Inc, Victoria (CA)

(72) Inventor: Philip Stanger, Victoria (CA)

(73) Assignee: WIFARER INC, Victoria (CA)

(21) Appl. No.: 13/645,940

(22) Filed: Oct. 5, 2012

Related U.S. Application Data
(60) Provisional application No. 61/543,733, filed on Oct. 5, 2011.

(51) Int. Cl. G06F 17/30

(52) U.S. Cl. 707/748; 707/736; 707/E17.005

(57) ABSTRACT

Content can be provided to mobile computing devices based on device location and demographic values associated with the mobile device and the location. A demographic or other user profile is stored, and, upon report of a user location in a covered venue, the user profile is queried and suitable content selected for delivery. The user demographic profile can include indications of one or more of user age, user gender, user educational background, user marital status, user income level, user ethnicity, user postal code and user price sensitivity. User profiles can be obtained based on user movement in a venue using demographic values associated with venue locations, and venue location profiles can be established based on user movement in a venue and the associated user demographic profiles.

### CROSS REFERENCE TO RELATED APPLICATION

This application claims the benefit of U.S. Provisional Application 61/543,733, filed Oct. 5, 2011, which is incorporated herein by reference.

### FIELD

The disclosure pertains to determining characteristic preferences and profiles of mobile users through their movements through various geographic locations and the provisioning of location based content based on those profiles.

### BACKGROUND

Visitors to public and private venues typically are responsive to information and content that is location appropriate and for which they have an interest. For example, customers are appreciative of special offers and discount coupons for items that they want that are presented during shopping, particularly if presented when they are located at or near the associated store Museum visitors can be similarly appreciative of information concerning nearby exhibits. Unfortunately, while location specific content can be desirable, most such content does not account for recipient characteristics other than possible recipient location. Identifying appropriate content requires information about users that is expensive and difficult to obtain. Accordingly, improved methods and apparatus for user-specific content delivery are required.

### SUMMARY

Methods and apparatus configured to determine characteristic preferences and profiles of mobile users through their movements through various geographic locations and to provision location relevant content based on those profiles are disclosed.

As disclosed herein, content can be provided to mobile computing devices based on device location and user profile values associated with the mobile device. In some examples, a demographic or other user profile is stored, and, upon report of a user location in a covered venue, the user profile is queried and suitable content selected for delivery. The user demographic profile can include indications of one or more of user age, user gender, user educational background, user marital status, user income level, user ethnicity, user postal code and user price sensitivity. User profiles can be obtained based on user movements in and about venues or physical locations using known demographic or user profile values associated with the locations, and location profiles can be established based on user movements in and about venues and the associated user demographic profiles.

According to some examples, methods comprise obtaining a reported location of a mobile station and associating the location of the mobile station with a geographic location. The geographic location values of interest are generally locations or areas to which values that can be pertinent to users can be or have been assigned. In some cases, a location profile is established based on demographic or Typical User Profile values associated with the mobile station. The Typical User Profile or demographic values associated with the mobile station include one of mobile station user age, user gender, user educational background, user marital status, user income level, user ethnicity, user postal code, and user price sensitivity. In some examples, the demographic or Typical User Profile values are obtained from a user profile stored in a computer readable medium. In other examples, a plurality of mobile stations having reported locations associated with the venue are identified, and the venue location profile is established based on Typical User Profile or demographic values associated with the plurality of mobile stations. In other examples, the reported locations of the plurality of mobile stations are obtained based on radio-frequency (RF) signals associated with wireless network RF signals. According to some embodiments, the reported locations of the plurality of mobile stations are obtained based on BSSIDs of wireless access points proximate to the mobile stations. In some examples, the venue location profile is established based on a weighting of the demographic values associated with the mobile stations.

User profiles can be established based on geographic locations such as specific locations, small or large areas, and/or areas or locations that are associated with a venue. In many cases, user profiles are preferably established based on specific locations or small areas such as points of sale as the associated location profile can be well defined.

Methods for delivering demographically targeted content include receiving a reported location of a mobile station based on one or more wireless or Bluetooth access points identified as proximate the mobile station. A venue location associated with the mobile station location is identified, and content for the mobile station is selected based on a user profile associated with the mobile station. In some examples, the user profile includes demographic values associated with user age, user gender, user educational background, user marital status, user income level, user ethnicity, user postal code, and user price sensitivity, and the content is selected based on at least one demographic value obtained from the user profile.

Mobile stations include a wireless transceiver and a processor configured to report at least one detected BSSID or SSID and receive content obtained based on the detected BSSID or SSID. In some examples, the mobile stations include a user interface configured for user authorization of reporting of the at least one detected BSSID or SSID. In other examples, the user interface is configured to authorize access to demographic values associated with the mobile station.

Methods of delivering content comprise establishing a user location in a venue. Based on a user profile, content associated with the user location in the venue is selected and delivered. Typically, the user profile includes indications of one or more of user age, user gender, user educational background, user marital status, user income level, user ethnicity, user postal code and user price sensitivity. In some examples, the user location in the venue is established based on at least one radio frequency (RF) signature or one or more wireless access point BSSIDs.

These and other features and aspects of the disclosed technology are set forth below with reference to the accompanying drawing.

### BRIEF DESCRIPTION OF THE DRAWINGS

FIG. 1 illustrates a representative computer environment for implementation of the disclosed methods.

FIG. 2 is a representative mobile device display associated with providing location based content showing an opt-in menu for allowing demographic data collection.

FIG. 3A is a flowchart of an exemplary method of establishing a location profile.

FIG. 3B is a flowchart of an exemplary method of establishing a user profile.

FIG. 3C is a flowchart of an exemplary method of updating a user profile.

FIG. 3D illustrates representative demographic values provided by a location profile.

FIG. 4 is a block diagram illustrating an exemplary method of providing targeted content to a user based on a user profile containing demographic and other data.

FIG. 5 illustrates a representative user profile that includes a demographic profile, a personal profile, and a professional profile any of which can be established or updated based on mobile station movements through locations with assigned values.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

For convenience, user actions are referred to in some of the following examples. Such actions typically refer to execution of computer-executable instructions by a computing device such as a computer, mobile phone, or other device. In some cases, “user” may be understood to refer to “user device.” It will be apparent that in many examples, user devices are responsive to user inputs at, for example, a touch screen or other input device.

Content associated with a particular location can be provided to a user of mobile communication device if the current location of the device is available. Surprisingly accurate and reliable location data can be established based on radiofrequency (RF) signatures that are developed based on local RF signals associated with wireless communications based on IEEE 802.11 standards or other wireless networking standards or configurations. As used herein, RF refers to electromagnetic signals of frequencies between 1 MHz and 100 GHz. By surveying local RF signals, and generating an RF signature based on the detected RF signals, RF signatures can be associated with spatial locations. Signals from one or more wireless access points can be detected at a plurality of locations so as to develop an RF signature map.

Although signatures are conveniently based on IEEE 802.11 protocols due to their widespread implementation, other RF signal-based protocols such those described in IEEE 802.15 such as so-called BLUETOOTH protocols and ZIGBEE protocols can be used. In some applications, these alternative standards are preferred. For example, ZIGBEE-based devices can be battery powered and thus continue to operate in situations in which power fails. In addition, Global Positioning System (GPS) based location data can be used. In other examples, RF signals associated with radio-frequency identification (RFID) can be used. RFID signals based on battery powered, RF powered, or other RFID tags can be used as may be convenient.

In the description of representative examples, location profiles are generally assigned to particular geographic locations. Examples of such locations include large area locations such as shopping malls, amusement parks, shopping districts, museums, and sports venues such as football stadiums. The geographic locations can be assigned location values based on goods or services offered or other features of the locations, as well as values extracted from or based on profiles of typical or selected visitors to the location. However, in most practical examples, more precise or specific geographical locations are of interest such as a location of a small shop, food stand, an aisle or other specific area of a department store or large discount store such as a restroom, or a vendor stand in a mall. In some cases, a venue comprises a set of value-assigned locations such as these. For example, a shopping mall can have one or more value-assigned locations corresponding to mall merchants. In some examples, geographical locations correspond to providers of goods and services such as merchant locations. For convenience, such locations are referred to a provider sites. Provider sites can also be divided further into sub-sites associated with different aspects or features of the provider site and situated at the same or other locations. A set of provider sub-sites can be assigned to a provider site. In other examples, unrelated value-assigned locations can be used, such as one or more shops in a downtown area that are not aggregated into a venue set. Such value-assigned locations need not be in a geographically limited area, as values can be assigned to locations throughout a city, country, or distributed worldwide. Specific geographical locations can be associated with multiple location profiles. For example, a food vendor location in a food court in a shopping mall can be associated with location profiles for its specific location and food court and mall location profiles in view of its location in the mall.

Visitors to value-assigned locations can be provided with user profiles that can be stored on a user mobile device or at a cloud-based server or at other locations. User profiles can include demographic data associated with the user or users of a mobile device, or other user characteristic information. Mobile stations can be configured to report data from which a geographical location can be estimated, or can be configured to process such data to determine location. Such processing typically requires download of location data to a mobile station. In other examples, mobile station locations are determined without active participation by the mobile station. For example, RF signals associated with an RFID tag at the mobile station can be detected, and the location of the mobile station determined based on the location of the RFID tag which can be reported to a server or other cloud-based computing device. Bar codes or QR codes can be similarly used. As used herein, establishing a user or location profiles refers to both adding values to a newly created profile such as a default or empty profile, or updating values in a pre-existing profile.

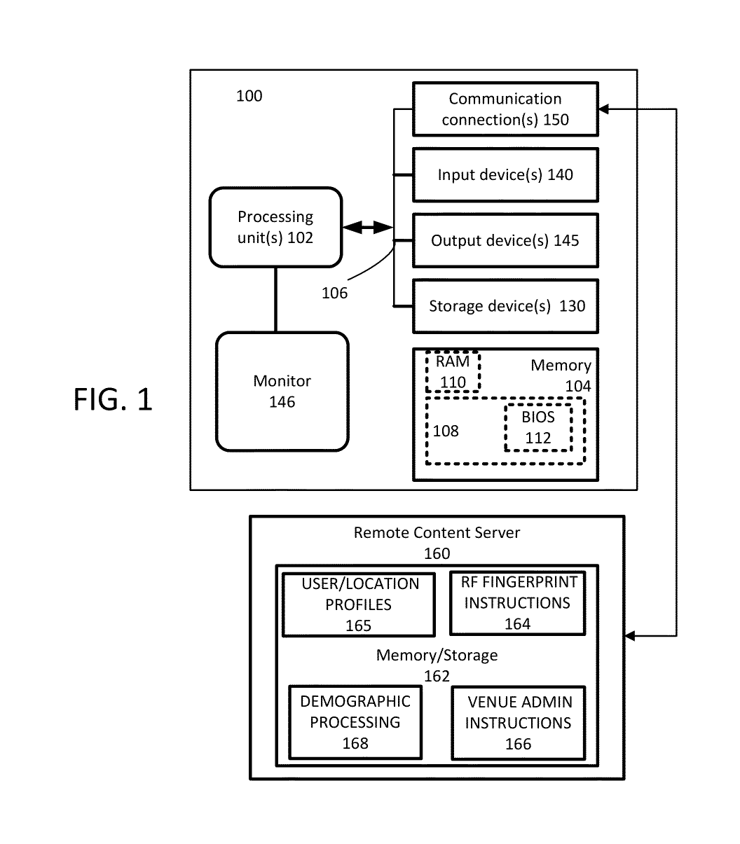

Representative examples are described with reference to particular hardware and software for convenient illustration. In particular, mobile devices that include a touch screen display are used in some examples. However, the disclosed methods and apparatus are not limited to such specific implementations and FIG. 1 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC) or other device, including mobile devices. Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the disclosed technology includes a computing device in the form of an exemplary user device 100, including one or more processing units 102, a system memory 104, and a system bus 106 that couples various system components including the system memory 104 to the one or more processing units 102. The system bus 106 may be any of several types of bus structures including a memory bus or memory controller, a peripheral bus, and a local bus using any of a variety of bus architectures. The exemplary system memory 104 includes read only memory (ROM) 108 and random access memory (RAM) 110. A basic input/output system (BIOS) 112, containing the basic routines that help with the transfer of information between elements within the user device 100, is stored in ROM 108.

Any of the disclosed methods can be implemented as computer-executable instructions or a computer program product. The computer-executable instructions or computer program products as well as any data created and used during implementation of the disclosed embodiments can be stored on one or more computer-readable media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other computing devices that include computing hardware). Computer-readable media does not include propagated signals. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

The exemplary user device 100 further includes one or more storage devices 130 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 106 by a hard disk drive interface, a magnetic disk drive interface, and an optical drive interface, respectively. The drives and their associated computer-readable media provide nonvolatile storage of computer-readable instructions, data structures, program modules, and other data for the user device 100. Other types of computer-readable media which can store data that is accessible by a user device, such as magnetic cassettes, flash memory cards, digital video disks, CDs, DVDs, RAMs, ROMs, and the like, may also be used in the exemplary operating environment.

A number of program modules may be stored in the storage devices 130 including an operating system, one or more application programs, other program modules, and program data. A user may enter commands and information into the user device 100 through one or more input devices 140 such as a keyboard and a pointing device such as a mouse. Other input devices may include a digital camera, microphone, joystick, game pad, satellite dish, scanner, or the like. These and other input devices are often connected to the one or more processing units 102 through a serial port interface that is coupled to the system bus 106, but may be connected by other interfaces such as a parallel port, game port, or universal serial bus (USB). A monitor 146 or other type of display device is also connected to the system bus 106 via an interface, such as a video adapter. Other peripheral output devices, such as speakers and printers (not shown), may be included.

The user device 100 may operate in a networked environment using logical connections to one or more remote computers, such as a content server 160. In some examples, one or more network or communication connections 150 are included. The content server 160 may be another user device, a server, a router, a network PC, or a peer device or other common network node, and typically includes many or all of the elements described above relative to the user device 100, although only a memory storage device 162 has been illustrated in FIG. 1. Typically, the memory storage device 162 is configured to store computer-executable instructions for venue administration 166, RF signature determination 164 and/or demographic processing 168. In addition, demographic or other profiles 165 for users and venue locations can be stored. The user device 100 and/or the content server 160 can be connected to a logical a local area network (LAN) and a wide area network (WAN). Such networking environments are commonplace in offices, enterprise-wide computer networks, intranets, and the Internet.

When used in a LAN networking environment, the user device 100 is connected to the LAN through a network interface. When used in a WAN networking environment, the user device 100 typically includes a modem or other means for establishing communications over the WAN, such as the Internet. In a networked environment, program modules depicted relative to the personal computer 100, or portions thereof, may be stored in the remote memory storage device or other locations on the LAN or WAN. The network connections shown are exemplary, and other means of establishing a communications link between the computers may be used.

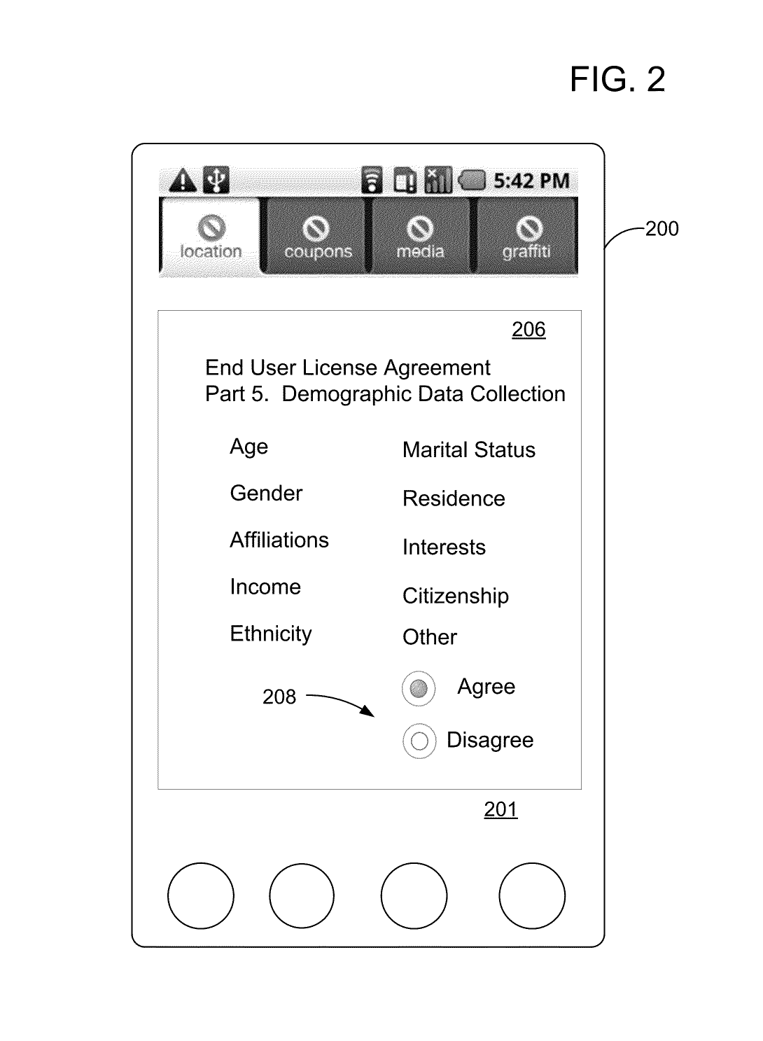

In a particular implementation illustrated in FIG. 2, a mobile station 200 includes a display 201 configured to present one or more location identifiers such as static or popups indicators or otherwise indicate the availability content associated with marked locations. The mobile station 200 can support one or more input devices such as a touch screen, microphone, cameras, physical keyboard and/or trackball and one or more output devices such as speakers, or piezoelectric or other haptic output devices. Content can also be provided to a user based on one or more of these output devices. The mobile station 200 can further include at least one input/output port (which can be, for example, a USB port, IEEE 1394 (FireWire) port, and/or RS-232 port), a satellite navigation system receiver such as a GPS receiver, a gyroscope, an accelerometer and a magnetometer. The mobile station 200 can report local RF signals associated with wireless networks so that an RF signature associated with the mobile device current location is obtained. Alternatively, the mobile device 201 can process received RF signals to produce an RF signature. The display 201 of the mobile station 200 can be used to display opt-in or opt-out menus concerning demographic and other data collection for use in a user profile and to obtain targeted content. Typically, an end user license agreement (EULA) is displayed in a display area 206 as one or more pages, and EULA terms such as the nature of demographic data to be used and collected are provided. In addition, a display area 208 is configured to indicate acceptance or rejection of the terms of the EULA using radio buttons. For convenience, mobile station components configured to report location or information that can be used to determine location such as BSSIDs of local access points, or to provide a mobile station or user identifier to a locating system such as an RFID system that correlates a mobile station with a particular location are referred to herein as a mobile station location system. Such systems can include, for example, powered or unpowered RFID tags or wireless receivers and transceivers.

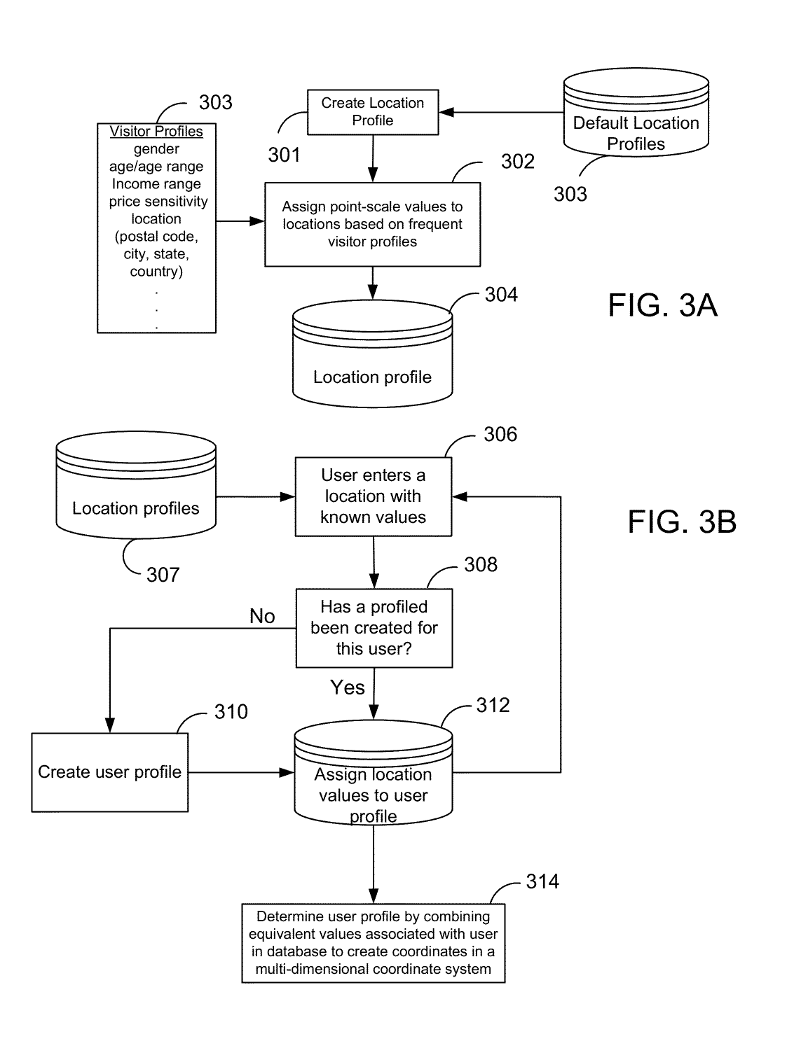

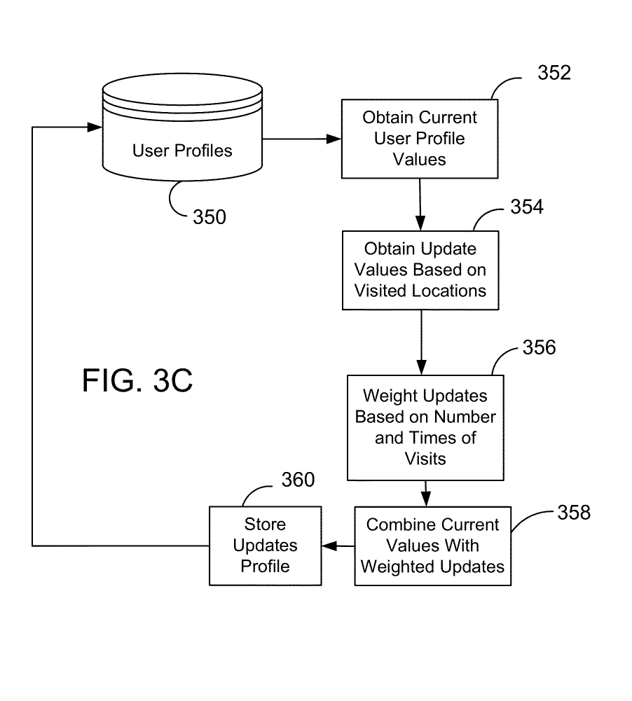

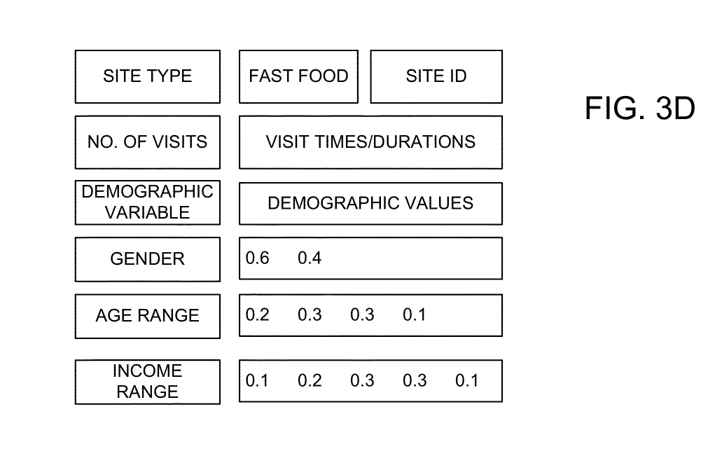

With reference to FIG. 3A, default location profiles are created at 301, based on previously known location values or default location profiles stored in a computer-readable memory at 303. The default values can be based on goods or services associated with a location, or other features of a location. For example, based on a classification of a particular location as a hardware store, a type of restaurant, or gender specific facilities such as washrooms, a location profile can be established using typical or default values for such locations. In some cases, default values are based on movement patterns associated with other uses at similar types of locations. At 302 point-scale values or other values are assigned to locations as defined by user profiles of frequent visitors to the locations that are obtained from a visitor profile database 303. One or more or all user characteristics of a visitor profile can be used, or only selected characteristics can be used. Known values associated with age, gender, price sensitivity, interests, user locations (such as postal code, home address, etc.), income range, ethnicity, marital status, education level and others can be stored in the location profiles at a database 304 based on corresponding user profile values. A location profile can also be established based on frequent visitors with 2, 4, 10, or more visits, or all visits can be used. In some examples, a location profile is established based on user profiles of visitors who have accessed goods or services at the location or who are frequently in the location. Such location profiles can take advantage of user profiles of actual purchasers, potential customers who visit but make no purchases, or both. In other examples, location profiles are obtained based on user profiles associated with users who are frequently at the location and/or those users whose presence is so transitory that they can be considered as not even considering purchases. In still other examples, a location profile can be established based on user profiles of all or substantially all users who visit the location. This may be especially useful in profiling a particular location for pre-existing visitor characteristics to identify a suitable type of business or service for the location.

Location profiles can be based on user profiles, and as shown in FIG. 3B, user profiles can in turn be based on location profiles. At 306, a user enters a known location that is either identified based on an RF signature obtained from local Wi-Fi characteristics such as one or more received signal strengths (RSS), Service Set Identifiers (SSID)s, or Basic Service Set Identifiers (BSSIDs) identifying particular access points (APs) or other geolocation information. For example, a user can approach a particular vendor location identified by BSSIDs of nearby APs. At 308, a database at the user mobile device or at a remote server is queried to determine if the user has a pre-existing profile. If so, values associated with the location profile of the current location are assigned to the user profile at 312. If the user does not have a user profile, one is created at 310, and the location's values added to the user profile at 312 or the location can be added so that associated values can be added subsequently. At 314, the user profile is updated by combining values from the current location with previous values. Typically, some or all values from a location profile are added to a user profile, or stored for processing for addition to a user profile. For example, values for each visited location can be obtained, and the values associated with each location averaged to obtain a profile value that is used to update or initiate the user profile. Values associated with more recent visits can be more heavily weighted, and values associated with older visits less heavily weighted. For example, only the most recent 10, 100, 1000, or 10,000 visits are used. Alternatively, point values from older visits can be given less weight such as weighting based on an exponential decay.

For example, a user having a new, but as yet empty profile enters a hardware store and subsequently enters a men's washroom. The men's washroom location profile includes a high point value associated with gender (male), but may lack other profile point values. The hardware store location profile can include values for gender such as a number between 0 and 1, wherein 0 refers to male and 1 to female, and a numerical value is assigned based on a probability of a particular gender. In addition, values associated with average purchase price (price sensitivity) can be provided. In some examples, estimates of user age or age range, probabilities of educational background, marital status, income level and ethnicity as well as a weighted average of sales prices can be added. Such values can be represented numerically or otherwise. While a location (i.e., vendor location) typically defines a location profile based on prior knowledge of customer profiles, in some examples, user profiles are used to define the location profile and prior knowledge of customer data is not required. Thus, both user and location profiles can be established without predefined values based on marketing surveys or other previously known customer data.

A representative method of establishing or updating a user profile is illustrated in FIG. 3C. At 352, current user profile values are extracted from a user profile data base 350. Values associated with locations visited by a user are obtained at 354, and these values are weighted at 356 based on numbers of visits and timing of visits. For example, multiple visits to the same location can be weighted based on the number of visits or a non-linear function of numbers of visits. In addition, older visits or visits at times as which products or services associated with the location are unavailable can be accorded less weight. At 358, the weighted updates are combined with current values. The current values can be stored as a previous set of values associate with visits so that the weighted updates can be combined with new weightings of the stored values. In some applications, the current values only are stored, and weighted updates are applied to the current values. In some cases, an extensive set of weighted updates can be used to replace the current values.

In one example, a visited location is associated with multiple demographic variable values. For example, as shown in FIG. 3D, one or more visits to a location associated with a fast food restaurant establishes location specific values. Numbers of visits, visit durations, and dates and times of visits are recorded along with a site identifier. As shown in FIG. 3D, normalized point values for gender classification are slightly different for male and female visitors (0.6 and 0.4, respectively), and certain age ranges are less likely to visit this location (for example, age range demographic values vary from 0.1 to 0.3). Demographic values such as shown in FIG. 3D can be assigned to a plurality of locations, and can include additional variables not shown in FIG. 3D. In addition, visitor details from which location specific demographic characteristics are determined are stored so that location demographic values can be recalculated as may be desired.

For some demographic values, user characteristics such as age, income, education are divided into ranges that can be fixed, variable, or site specific. Informative ranges for shopping malls, sports venues, amusement parks, museums, or other locations may be different. In such cases, location profiles or visitor profiles adapted for a particular venue may be inappropriate for other venues. Accordingly, profiles may be computed as needed based on recorded visit data, and such recorded visit data stored in a profile so as to permit determination of specialized values. For example, user information such as exact age and residence can be stored and provided for use in generating a location profile. A user profile can be established based on location profiles received from a plurality of locations, with demographic ranges associated with each location provided.

Location profile information can be combined to establish a user profile in a variety of ways. As a user visits locations to which location profiles or other values are assigned, selected location values are extracted and used in determining or updating a user profile. For example, a female mobile station user (with no gender preference yet established in her user profile) visits locations whose gender values are associated with female visitor such as two clothing stores for woman and a women's washroom. If gender values range from 0 (female) to 1 (male), the female visitor's user profile can have an initial values of 0.5 (no gender preference). If the clothing stores have gender values of 0.3 and 0.15, and the washroom has a gender value of 0, a gender value of 0.15 can be assigned based on the average of these values. As the user visits additional sites, additional gender values are extracted for addition to the user profile. Other user profile values can be obtained in the same manner. As a result, a user profile can be established that includes values for a variety of user characteristics to be targeted,

It can be convenient to establish user location based on RF signatures derived from local wireless network access points, but user location can be based on GPS positioning, near field communications such as those based on BLUETOOTH communications. In other examples, a user RFID chip can be detected and user location obtained based on the detection location. For example, a vendor detect the user RFID and communicate the user location to a content server so that location and user targeted content can be provided. Alternatively, a user can scan Quick Response (QR) code or bar code displayed at a particular location with, for example, a camera on a user mobile device. The user mobile device can decode the QR code and transmit a message based on the decoding to a content server that can determine user location by evaluation of the transmitted message. Alternatively, the code can include location information, and the user mobile device can communicate location information to the content server.

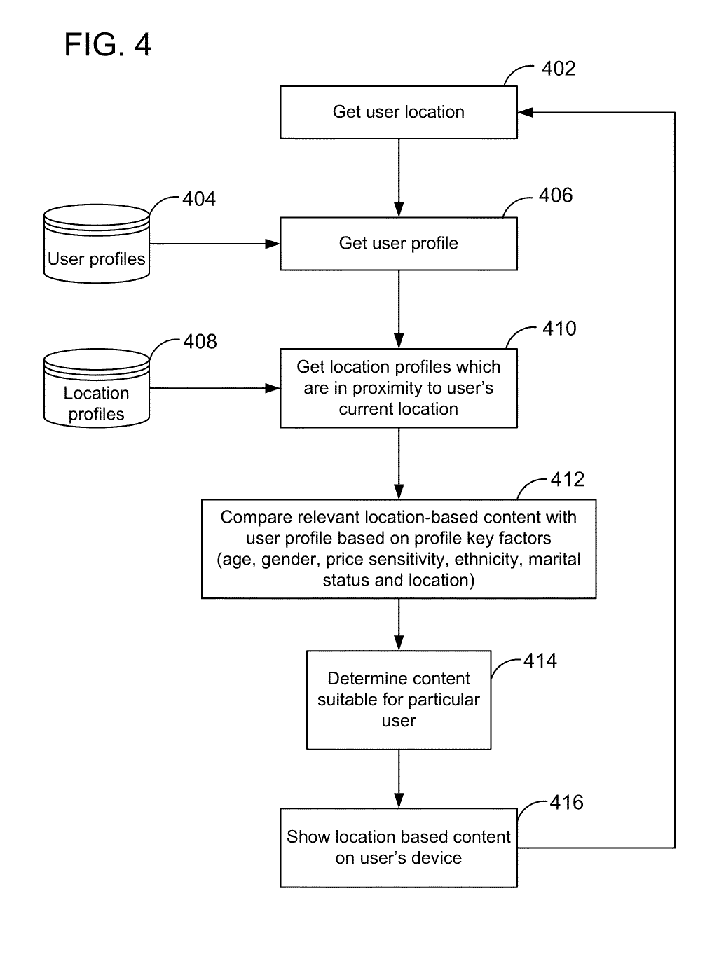

User profiles can permit delivery of targeted location based content as shown in FIG. 4. At 402, a user location is obtained through a variety of geolocation techniques, but generally based on a wireless survey of one or more nearby APs by the user's mobile device to obtain RF signatures. In some examples, the mobile device is configured to store locations and corresponding RF signatures. Alternatively, locations and signatures can be stored at a remote location such as a content provisioning server, and the user mobile device reports local AP survey results to a remote content server. At 406, a user profile is retrieved from a user profile database 404, and at 410, location profiles proximate the current user location are obtained from a location profile database 408. At 412, the user profile and location profiles are searched to determine suitable locations or location based content for display to a user at the user mobile device. Location and user profiles can be searched for common or similar entries regarding, for example, price point, age, gender, educational background, marital status, income level, ethnicity etc. At 414, content is selected for display based on search results associated with common or similar profile entries. For similar (i.e., selected entries), content can be presented to a user at 416 such as one or more coupons, advertisements, special offers, or other general or specific information. In some cases, only locations selected based on user and location profiles are noted on a displayed venue map at the user mobile device.

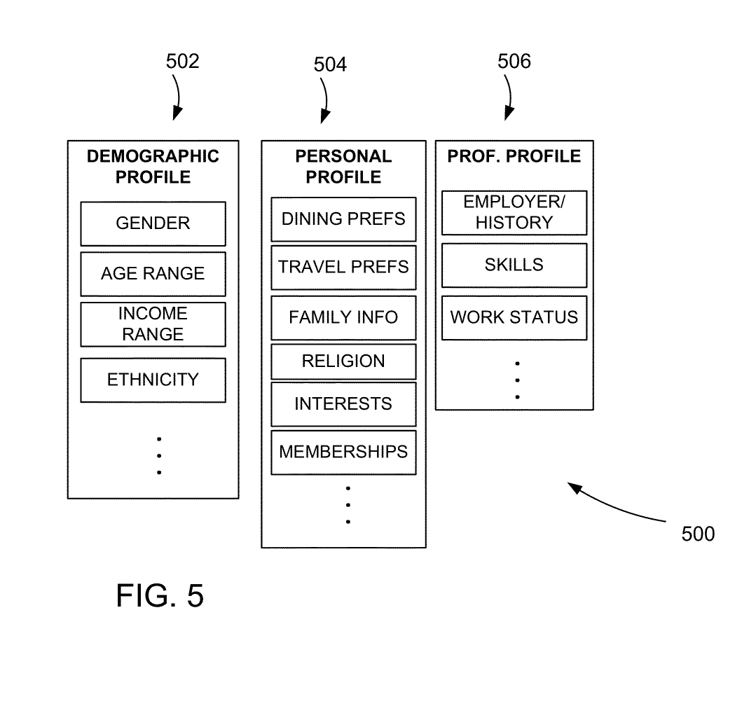

FIG. 5 illustrates a representative user profile 500 that is stored in a memory device. In this example, a demographic profile 502, a personal profile 504, and a professional profile 506 are included. Typical categories of demographic profiles are discussed above. The personal profile 504 can include dining or travel preferences such as particular restaurants or types of restaurants, and airlines and hotels commonly used. These can be established based on restaurant visits detected based on reported mobile station location, or airline or hotel check-in counter locations. Religious values can be estimated based on reported locations associated with places of worship, and family information can be established based on reported mobile station visits to schools, colleges, youth facilities, or other locations. Values associated with social organization memberships can be based on visits to organization facilities, and other personal interests can be established based on visits to recreational facilities, shops, or other locations. For example, a woodworking interest can be established based on visits to tool and lumber suppliers. Interests in sports can be established based on stadium attendance or presence at other locations such as tennis courts, golf courses, and shooting ranges. The professional profile 506 can include values associated with current employment and employment history based on visits and histories of visits to work places. Work status and likely skill sets can similarly be inferred. In some cases, user values from some or all such profiles can be used to establish or update values in new profiles or existing or new profile categories. Thus, based on user movements (as reported based on user mobile station movement), a user profile can be established without user intervention and include broad ranges of categories.

A location such as a provider site can identify preferred user characteristics and identify user-relevant content. User and/or location profiles can be arranged as vectors or matrices that include values for various user and location characteristics. A location profile can be compared with corresponding user profile values as a vector difference of profile values. Content to be delivered to a user can then be selected based on a magnitude or direction of the vector difference, or a combination thereof. Different sets of profile values can be used, so that profile vectors or sub-vectors of different dimensionalities can be used in different comparisons.

The provisioning of different content based on vector profile differences can be illustrated as follows. A user with a strongly female gender value is reported at a provider location for which males are targeted purchasers. In response to the strong female gender value, content associated with gift purchasing for a man can be provided such as lists of popular items. If a user with strongly male gender values is reported, the provider can identify different content such as a discount coupon or notice of an upcoming special event. In typical examples, content is provisioned based on multiple user values, and not a single user value. If a provider seeks customers with high incomes or tendency to make expensive purchases, content for less affluent purchasers can be geared toward less expensive items, or no content at all provided.

It will be appreciated that the examples above are provided for convenient illustration, and should not be taken as limiting the scope of the disclosure. I claim all that is encompassed by the appended claims.

I claim:

1. A method, comprising:
obtaining a reported location of a mobile station;
associating the mobile station with assigned values of the location; and
establishing a location profile based on at least one user value associated with the mobile station.

2. The method of claim 1, wherein the user values associated with the mobile station are demographic values that include at least one of user age, user gender, user educational background, user marital status, user income level, user ethnicity, user postal code, and user price sensitivity.

3. The method of claim 1, further comprising obtaining the at least one user value from a user profile associated with the mobile station, and the location profile is established based in part on predetermined values associated a goods or service provider at the reported location.

4. The method of claim 1, further comprising identifying a plurality of mobile stations having a common reported location, wherein the location profile is established based on user values associated with the plurality of mobile stations.

5. The method of claim 4, wherein at least one of the reported locations is based on radio-frequency (RF) signals associated with wireless network RF signals or Global Positioning System coordinates.

6. The method of claim 4, wherein the user values are obtained from user profiles associated with the plurality of mobile stations.

7. The method of claim 6, wherein the common reported location is a provider site.

8. The method of claim 6, wherein the common reported location is a provider sub-site, and location profiles for the provider site and the provider sub-cite are established based on the user profiles.

9. The method of claim 6, wherein the location profile is established based on a weighting of the demographic values obtained from the user profiles.

10. A computer-readable medium having stored thereon computer-executable instructions for the method of claim 1.

11. A system for establishing location profiles, comprising:
a processor configured to obtain a reported location of a mobile station and establish a location profile based on at least one user value associated with report; and
a memory device configured to receive and store the established location profile.

12. The system of claim 11, wherein the at least one user value associated with the report is based on the reporting mobile station.

13. The system of claim 11, wherein the processor is configured to obtain a plurality of reported locations and establish corresponding location profiles based on user values associated with the reports.

14. The system of claim 13, wherein the user values associated with the report are based on at least one user profile associated with a mobile station.

15. The system of claim 14, wherein the processor is configured to establish the location profiles based on a weighting of user values associated with the reports.

16. A method, comprising:
receiving a reported location of a mobile station
identifying a location to which values have been assigned that is associated with the reported mobile station location; and
selecting content for the mobile station based on a user profile associated with the mobile station and the identified location.

17. The method of claim 16, wherein the reported location is based on one or more wireless access points identified as proximate the mobile station.

18. The method of claim 16, wherein the user profile includes demographic values associated with user age, user gender, user educational background, user marital status, user income level, user ethnicity, user postal code, and user price sensitivity, and wherein the content is selected based on at least one demographic value obtained from the user profile.

19. The method of claim 16, wherein the location is associated with a set of locations that define a venue wherein the selected content is associated with the user location in the venue, and further comprising delivering the selected content.

20. The method of claim 19, wherein the location is associated with a provider site and a provider sub-site, and content associated with the site and the sub-cite is provided.

21. The method of claim 16, wherein the user location is established based on at least one radio frequency (RF) signature or at least one BSSID.

22. A mobile station, comprising:
a location system configured to communicate at least one of a mobile station identifier or information associated with mobile station location;
a transceiver configured to receive user and location targeted content responsive to the communication identifier or information; and
a processor configured to present location targeted content to a user.

23. The mobile station of claim 22, wherein the location system is configured to communicate location information based on detected radio frequency signals.

24. The mobile station of claim 22, further comprising a display in communication with the processor and situated to present a menu associated with authorization of access to a user profile.

25. The mobile station of claim 22, further comprising a user interface configured for user authorization of reporting of at least one detected BSSID.

26. A method, comprising:
detecting a mobile station at a plurality of locations associated with location profiles; and
based on the location profiles associated with the plurality of locations, establishing a user profile.

27. The method of claim 26, wherein the user profile includes demographic values associated with at least one of user age, user gender, user educational background, user marital status, user income level, user ethnicity, user postal code, and user price sensitivity.

28. The method of claim 26, wherein the mobile station is detected at at least some of the plurality of locations based on radiofrequency signals associated with a wireless network or GPS coordinates.

29. The method of claim 27, wherein the locations are associated with provider sites.

30. The method of claim 26, wherein the user profile is established based on a weighting of data from the location profiles in which more frequent and more recent visits are weighted more heavily.

31. A system configured to establish user profiles, comprising:
a server configured to identify location profiles associated with mobile station locations and assign at least one value to a user profile based on the location profiles; and
a memory device configured to store at least one user profile.
